(19) United States
(12) Patent Application Publication
(10) Pub. No.: US 2008/0029356 A1
(43) Pub. Date: Feb. 7, 2008

(54) Floating Brake Caliper Disk Brake With Guide Pins

(76) Inventors: Georg Halasy-Wimmer, Vaihingen (DE); Joachim Rehm, Frankfurt/M (DE); Andreas Pohlmann, Eschborn (DE); Peter Schack, Seligenstadt (DE); Stefan Johannes Schmitt, Eltville (DE)

Correspondence Address: CONTINENTAL TEVES, INC., ONE CONTINENTAL DRIVE, AUBURN HILLLS, MI, 48326-1581, US

(21) Appl. No.: 11/629,067

(22) PCT Filed: Mar. 24, 2005
(86) PCT No.: PCT/EP05/51388

§ 371 Date: Dec. 8, 2006

(30) Foreign Application Priority Data
Jun. 18, 2004 (DE) 102004029462.3

(51) Int. Cl. F16D 55/22

(52) U.S. Cl. 188/73.45

(57) ABSTRACT

A floating-caliper disc brake of a motor vehicle has a component fixed to the vehicle, in particular a brake support member, and a floating caliper (2) that is displaceably mounted on the component fixed to the vehicle by way of at least two pin guides (10, 20). A first pin guide (10) includes a carrier pin (11), among others, for the transmission of brake circumferential forces. A second pin guide pin (20) includes a guide pin (21, 21′, 41) for positioning the floating caliper (2) perpendicular to its direction of displacement. To improve the floating-caliper guide, among others when high brake circumferential forces prevail, it the second pin guide (20) constitutes a multipart guide pin (21, 21′, 41), with a pin (22, 22′, 42), an elastic sleeve (23, 45, 50, 55) encompassing the pin (22, 22′, 42), and with a sliding bushing (28, 28′, 38) encompassing the elastic sleeve (23, 45, 50, 55).

### BACKGROUND OF THE INVENTION

The present invention relates to a floating-caliper disc brake of a motor vehicle with a component fixed to the vehicle, in particular a brake support member, and with a floating caliper that is mounted on the component fixed to the vehicle in a displaceable fashion by way of at least two pin guides.

EP 0 341 610 B1 discloses a spot-type disc brake, wherein a floating caliper straddling a brake disc and brake pads arranged on either side of the brake disc is displaceably mounted on a brake support member that is fixed to the vehicle. Two pin guides with two guide pins are provided for this purpose, which latter pins are respectively screwed to the brake support member fixed to the vehicle and extend with a play into an associated bore in the floating caliper. Especially elastic damping sleeves are arranged between guide pins and bore. Basically, the pin guides with their guide pins of this arrangement do not transmit brake circumferential forces, because the brake pads are directly supported on the brake support member in a circumferential direction. Due to the damping sleeves, a floating caliper of this type is thus guided by way of the pin guides in a tangentially elastical fashion on the brake support member fixed to the vehicle. Especially with large and heavy floating calipers, this fact has a negative effect on the floating caliper guide, functional problems of the spot-type disc brake ensuing therefrom.

DE 196 26 296 A1 further discloses a floating-caliper spot-type disc brake with a floating caliper, which is displaceably mounted on a brake support member fixed to the vehicle by way of two differently designed pin guides. In this arrangement, the brake support member is integrated into the steering knuckle of a motor vehicle. One of the pin guides is designed as an immovable bearing, which acts perpendicular to the direction of displacement of the floating caliper and is used to transmit brake circumferential forces. The purpose of the pin guide designed as an immovable bearing is to introduce the developing brake circumferential forces at least proportionally into the brake support member that is fixed to the vehicle. A second pin guide merely serves for the slidable fixation of the floating caliper on the brake support member and the accommodation of torques that act on the floating caliper. The two pin guides each comprise a guide element fastened at the brake support member and extending with a guiding portion into an associated bore in the floating caliper. However, the two pin guides have different designs, especially due to their different functions. This results in an asymmetric configuration of the floating caliper or the brake support member, respectively, thereby impairing the use of identical brake components on both sides of the motor vehicle. In addition, the transmission of high brake circumferential forces is possible only when the pin guide of the immovable bearing is dimensioned at a correspondingly large extent.

Based on the above, an object of the invention is to disclose a floating-caliper disc brake with pin guides, which allows transmitting high brake circumferential forces, while a simple construction is maintained.

### SUMMARY OF THE INVENTION

This object is achieved by a floating-caliper disc brake with a component fixed to the vehicle, in particular a brake support member, a floating caliper, and at least two pin guides, which comprise in each case one carrier pin and one guide pin for the slidable arrangement of the floating caliper on the component fixed to the vehicle. The pin guides are defined in each case with a first end of the carrier pin or guide pin at the component fixed to the vehicle or at the floating caliper, in particular in a detachable fashion, while they are arranged with a guiding portion provided at the second end in a displaceable manner in a bore of the floating caliper or of the component fixed to the vehicle, respectively. One first pin guide, in addition to its guiding function, is appropriate among others for the transmission of brake circumferential forces and comprises a carrier pin to this end. Another, a second pin guide comprises a guide pin for the well-defined positioning of the floating caliper vertical to its direction of displacement. In this arrangement, both the carrier pin and the guide pin each extend directly with its guiding portion into the associated bore of the floating caliper or of the component fixed to the vehicle, respectively. This facilitates the direct transmission of brake circumferential forces, in particular when using the correspondingly dimensioned first pin guide with carrier pin. According to the invention, the second pin guide includes a multipart guide pin, with a pin, an elastic sleeve encompassing the pin, and with a sliding bushing encompassing the elastic sleeve. The guiding portion of the multipart guide pin is provided on the outward sliding bushing. The elastic sleeve allows compensating for manufacturing tolerances so that mutual tilting of the two pin guides is prevented. This provision generally allows ease of slidability of the floating caliper.

A preferred variation of the floating-caliper disc brake with pin guides is achieved in that the first pin guide includes a one-piece carrier pin. This fact serves to reduce the number of components and achieves a high-strength design of the carrier pin in addition. The carrier pin, which is used to transmit at least an essential portion of the brake circumferential forces, can have a solid and a hollow configuration.

A favorable design of the floating-caliper disc brake with pin guides is achieved in that the guiding portion of the first pin guide and the guiding portion of the second pin guide have the same outside diameter. From this results a basically symmetric design of the floating caliper or of the component fixed to the vehicle with associated bores. A floating-caliper disc brake of this type can be used on both vehicle sides in particular in a uniform design. Further, the pin guides with identical outside dimensions, depending on the respective requirements, allow the individually adapted positioning of the carrier pin and the guide pin. In this arrangement, the carrier pin of the first pin guide is arranged preferably in an exit-side portion of the floating caliper with reference to the main direction of rotation of an associated brake disc. Accordingly, the guide pin of the second pin guide is positioned in an entry-side portion of the floating caliper. However, this preferred type of positioning carrier and guide pins can also be changed, especially depending on the respective tangential supporting conditions of the brake pads in the floating caliper.

To improve the floating-caliper disc brake with pin guides, it can be arranged that the carrier pin, at its first end, is defined by way of a conical surface on the component fixed to the vehicle or on the floating caliper, especially in a detachable fashion. The actual removable attachment of the carrier pin is carried out especially by way of a screw coupling. As this occurs, the conical surface of the carrier pin moves in contact with an associated conical opposite surface of the component fixed to the vehicle or of the floating caliper. This facilitates the centering of the carrier pin, that is screwed in particular, on the one hand, and the transmission of brake circumferential forces into a component fixed to the vehicle, on the other hand. It is furthermore provided as an appropriate embodiment of the pin guides that even the multipart guide pin is defined at its first end by way of a conical surface on the component fixed to with the vehicle or on the floating caliper.

Another favorable variation of the floating-caliper disc brake with pin guides is achieved because the elastic sleeve is provided on the inside and/or outside surface with a suitable profiling in order to purposefully adjust the elastic effect perpendicular to the direction of displacement. The elastic sleeve essentially serves for the tolerance compensation perpendicular to the direction of displacement of the floating caliper. This prevents tilting of the floating caliper or the pin guides relative to each other, which would impair the displacement of the floating caliper in an undesirable manner.

To improve the pin guide, it is expedient to configure the elastic sleeve in such a way that it allows a limited elastic deformation in a radial direction with respect to the pin axis and, in addition, has a radial stop. Initially, this fact ensures the radially elastic effect of the pin guide with the multipart guide pin. Further, the radial stop enables a limited transmission of brake circumferential forces through the pin guide with the multipart guide pin, however, when the limit of elastic deformation in a radial direction has been exceeded. In this arrangement, the radial stop of the elastic sleeve may e.g. be realized by several radial extensions on the elastic sleeve.

According to a favorable embodiment, the elastic sleeve, at least in sections, is composed of an elastic material, in particular rubber material. As an alternative, it is also possible to choose a foam-type sleeve design with air inclusions or other suitable gas inclusions. The elastic effect of the sleeve is generally achieved by the material properties of the sleeve.

Apart from the selection of the material for the elastic sleeve, the elastic effect of the sleeve is determined above all by its specific design. To this end, a profiling is formed at the inside and/or outside surface of the elastic sleeve, for example, in the form of ribs, knobs, or other suitable elevations or indentations, respectively. Provisions of this type allow purposefully adjusting the radial elasticity of the elastic sleeve that is desired with respect to the pin axis. More particularly, the elastic sleeve is designed as a tolerance sleeve according to another preferred embodiment, which is made of a material of low elastic properties, at least in sections, and permits a limited elastic deformation in a radial direction due to its appropriate configuration. Accordingly, the tolerance sleeve may e.g. be made of sheet metal, and the desired radially elastic effect is adjusted by a specific shaping operation.

Further suitable detail features of the invention can be seen in the embodiments in the Figures, which are explained more closely in the following.

### BRIEF DESCRIPTION OF THE DRAWINGS

In the drawings:

FIG. 1 shows a spatial view of a floating-caliper disc brake with pin guides;

FIG. 2 is a spatial detail view of a one-piece carrier pin;

FIG. 3 is a spatial detail view of a multipart guide pin in a first embodiment;

FIG. 4 is a spatial detail view of a multipart guide pin in a second embodiment;

FIG. 5 is a spatial detail view of a multipart guide pin in a third embodiment;

FIG. 6 is a spatial detail view of a multipart guide pin in a fourth embodiment;

FIG. 7 is a spatial detail view of a multipart guide pin in a fifth embodiment.

### DETAILED DESCRIPTION OF THE DRAWINGS

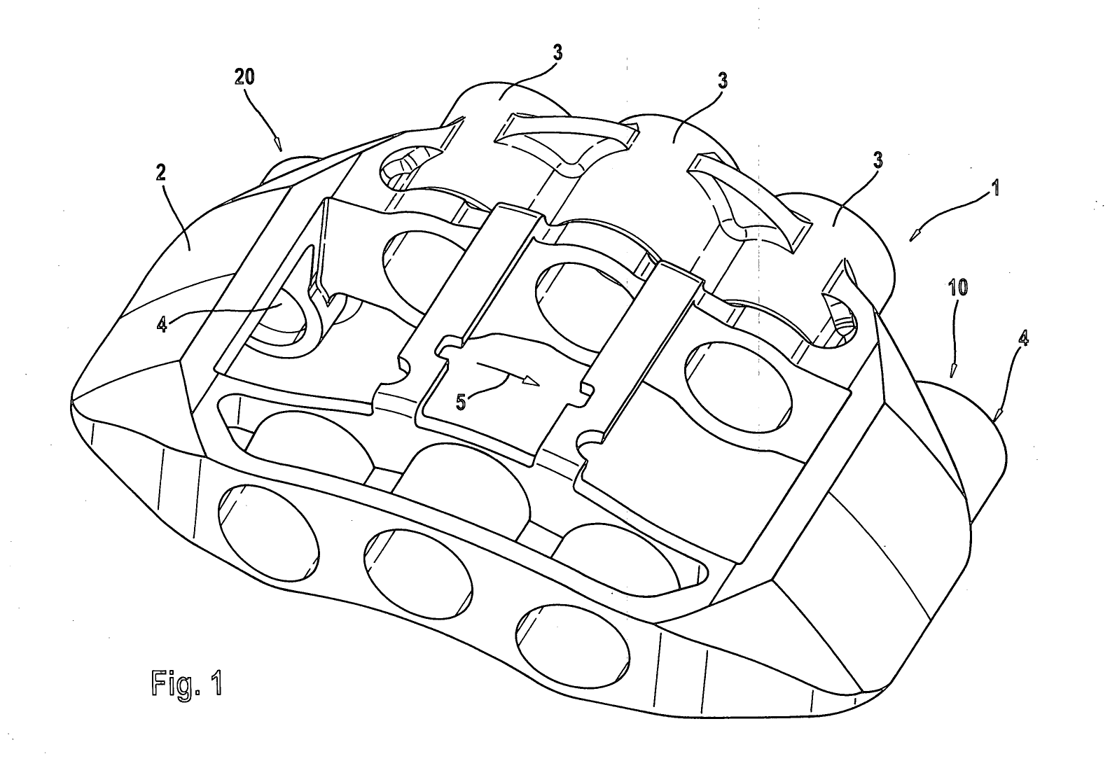

The floating-caliper disc brake 1 of a motor vehicle as illustrated in FIG. 1 comprises a floating caliper 2, which is displaceably mounted on a component fixed to the vehicle (not shown), especially a brake support member. For the slidable arrangement of the floating caliper 2, pin guides 10, 20 are provided, which act in particular between the component fixed to the vehicle, e.g. the brake support member, and the floating caliper 2. The floating caliper 2 straddles a brake disc (not shown) and associated brake pads arranged on either side of the brake disc. The brake pads, in turn, are supported tangentially in the floating caliper 2 for the transmission of brake circumferential forces. A brake pad that is positioned axially inwards on brake actuation devices 3 is additionally guided axially slidably and supported radially in the floating caliper. Alternatively, the axially inward brake pad can also be guided and supported on the carrier and guide pins, with the latter pins being required to include corresponding additional brake pad guiding portions. On the other hand, the axially outward brake pad that is arranged on the opposite brake disc side is rigidly coupled to the floating caliper and, hence, follows its axial movements. In this connection, the indications of direction refer to the axis of rotation of the associated brake disc. In detail, the floating caliper 2 on a first brake disc side includes several actuation devices 3, by means of which the brake pad on this side can be moved directly into frictional abutment with the brake disc. The brake pad on the opposed second brake disc side, however, is urged against the brake disc indirectly by axial displacement of the floating caliper 2. The floating caliper 2 is then designed with three actuation devices and a light-weight construction as high-performance brake caliper.

For the axially slidable floating-caliper arrangement, the two pin guides 10, 20 comprise a carrier pin 11 or guide pin 21, which are each fastened at the component fixed to the vehicle or to the floating caliper 2, respectively, on the one hand. They are slidably arranged with a guiding portion in a bore 4 of the floating caliper 2 or of the component fixed to the vehicle, on the other hand. According to the embodiment illustrated in the Figures, each of the carrier pins 11 or guide pins 21 is attached with a first end at the component fixed to the vehicle, in particular at the brake support member, and is slidably received with its second end in a bore 4 of the floating caliper 2. A first pin guide 10 among others comprises a carrier pin 11, which is used to accommodate and transmit the brake circumferential forces that develop. The second pin guide 20, among others, comprises a guide pin 21 and is basically used to position the floating caliper 2 on the component fixed to the vehicle, and namely perpendicular to its direction of displacement. With respect to the main direction of rotation 5 of the brake disc (not shown), the first pin guide 10 with carrier pin 11 is preferably arranged in an exit-side portion of the floating caliper 2. This arrangement results in particular with brake pads with push-type support in the floating caliper 2 and allows a favorably short flux of forces through the floating caliper 2 when brake circumferential forces develop. Accordingly, the second pin guide 20 with guide pin 21 is positioned in an entry-side portion of the floating caliper 2. As a whole, the design of the pin guides with a carrier pin 11 and guide pin 21 allows transmitting very high brake circumferential forces.

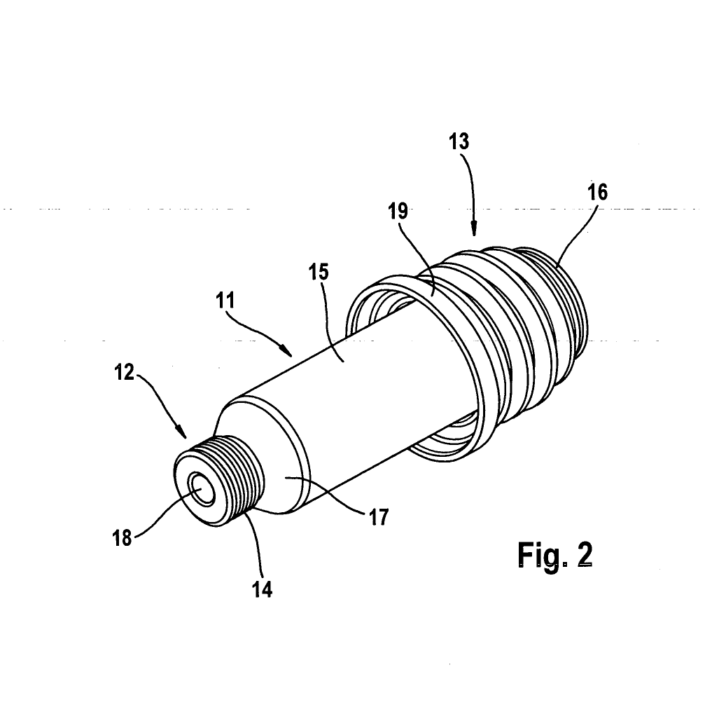

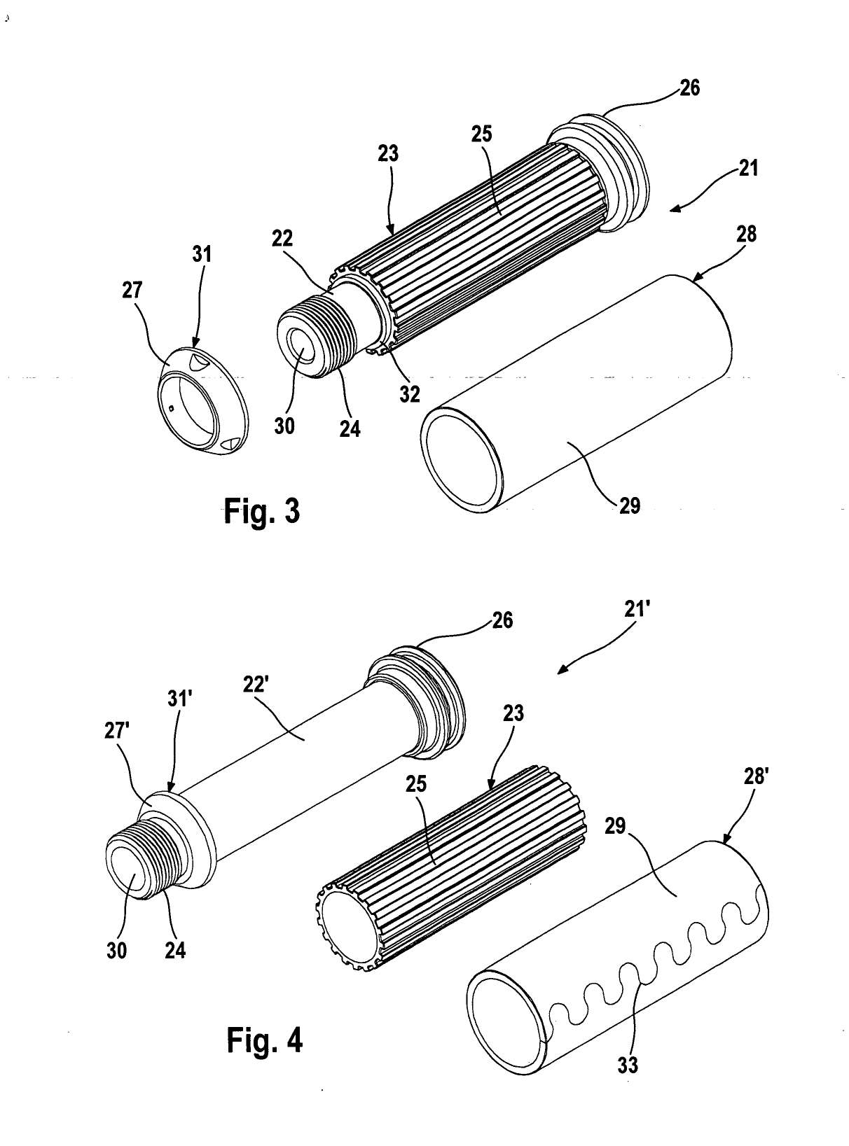

The design of the individual pin guides 10, 20 in detail is essentially described by making reference to FIGS. 2 to 7. Accordingly, FIG. 2 illustrates a carrier pin 11, and FIGS. 3 to 7 show several design variations of guide pins 21, 21′. The preferably one-piece carrier pin 11 has at its first end 12 a thread 14 for the detachable fastening of the carrier pin 11 at the component fixed to the vehicle or at the floating caliper 2, respectively. Of course, other types of attachment are also feasible, which especially allow detachable fastening of the carrier pin 11. On its opposed second end 13, the carrier pin 11 includes a guiding portion 15, which is slidably received in an associated bore 4 of the floating caliper 2 or of the component fixed to the vehicle, when in its mounted condition. More specifically, the guiding portion 15 extends with little play directly into an associated bore 4 of the floating caliper 2 or the component fixed to the vehicle, respectively. A comfortable floating-caliper guide is hereby achieved as well as a simple accommodation of brake circumferential forces, among others also extensive ones. For the simple attachment of the carrier pin, the second carrier pin end 13 ends with a head piece 16, on which a tool holding fixture (not shown) for placement of a screw coupling tool is provided. This allows screw coupling the carrier pin 11 in a simple fashion for assembly purposes. In addition, a conical surface 17 is provided at the first carrier pin end 12 between the thread 14 and the guiding portion 15. When the carrier pin 11 is screwed, this conical surface 17 bears against a correspondingly configured conical opposite surface of the component fixed to the vehicle or the floating caliper. On the one hand, this facilitates centering the carrier pin during the screw coupling, while the transmission of brake circumferential forces with least possible stress into a component fixed to the vehicle is improved, on the other hand. For further weight economy, the carrier pin 11 is of hollow design and, consequently, has a through-bore 18 in particular. Further, an elastic protective cap 19 is arranged at the carrier pin 11 according to FIG. 2 and is active between the carrier pin 11 and the floating caliper 2 or the component fixed to the vehicle, respectively. The protective cap 19 is adapted to be axially compressed, with the result that it follows the axial displacement travel of the floating caliper 2, thereby principally preventing the ingress of dirt and moisture into the first pin guide 10 with carrier pin 11. This fact will reliably ensure ease of motion of the first pin guide 11.

A first design variation of a multipart guide pin 21 in a second pin guide 20 is shown in FIG. 3. The guide pin 21 embraces an inward pin 22, which similar to carrier pin 11 includes a thread 24 and a head piece 26 with tool mounting fixture for screw coupling the guide pin 21. Alternatively, other attachment variations, especially detachable ones, are likewise feasible. The pin 22 can have a hollow design to reach weight economy, and it includes a through-bore 30 in particular. A separate ring 31 with a conical surface 27 is provided to improve the attachment or screw coupling of the multipart guide pin 21 corresponding to the carrier pin design. During the assembly of the guide pin 21, the ring 31 is slipped over the thread 24 onto the pin 22 and abuts there on an axial stop 32 shaped at the pin 22. It is furthermore possible to hold the ring 31 captive by fixing it at the pin 22 e.g. by means of a correspondingly rated fit. This allows comfortably centering the pin 22 during the screw coupling by way of the ring 31 with conical surface 27. This fact additionally facilitates the transmission of developing forces.

The pin 22 is encompassed by an elastic sleeve 23, which ideally is slipped onto ring 31 already prior to its assembly. This elastic sleeve 23 is made of a suitable elastic material, e.g. rubber. Alternatively, it is also possible to design the elastic sleeve 23 like foam with air inclusions or other suitable gas inclusions in order to adjust the desired radially elastic effect, as the purpose may be. For the continued purposeful adjustment of the elastic effect, the elastic sleeve 23 is provided with an appropriate profiling 25 at the inside and/or outside surface. A profiling 25 of this type can consist of ribs, knobs, projections, or other elevations or indentations, for example. A specific material selection and shape of the employed profiling 25 will thus allow adjusting the desired elastic effect perpendicular to the direction of displacement of the floating caliper 2. This radially elastic effect serves for the compensation of manufacturing tolerances and additionally prevents tilting of the pin guides 10, 20 in a reliable manner. Permanent ease of motion within the pin guides 20 is achieved due to the elastic effect of the second pin guide 20 perpendicular to the direction of displacement.

The elastic sleeve 23, in turn, is encompassed in its mounted condition by a sliding bushing 28, on which the guiding portion 29 is designed. The sliding bushing 28 essentially has a rigid design so that the radially elastic effect of the second pin guide 20 is achieved from the elastic sleeve 23 of the multipart guide pin 21 alone. The sliding bushing 28 is arranged with axial play between the ring 31 and the head piece 26 of the pin 22. This allows compensating manufacturing tolerances and prevents the pin guides 10, 20 from tilting.

FIG. 4 shows a design of a multipart guide pin 21′ that is modified compared to the above design. In this Figure, the ring 31′ with conical surface 27′ is formed directly integrally with the pin 22′. The function of the conical surface 27′ for facilitating the pin centering as well as the force transmission stays principally unaffected thereby. Due to its radially elastic properties, the elastic sleeve 23 allows being mounted in axial direction also over the ring 31′ onto the pin 22′. This is not possible for the rigid sliding bushing 28′. The sliding bushing 28′ has a slit design with a toothed cutting direction 33. A very rigid design of the sliding bushing 28′ is achieved in the mounted condition due to the toothed cutting direction 33. In general, the slit sliding bushing 28′ can be manufactured favorably of a plane material blank. In the opened condition, the slit sliding bushing 28′ thus allows being easily slipped over the ring 31′ onto the pin 22′ and being subsequently joined at the toothed edges of cut 33. Of course, other suitable, toothed cutting directions 33 are also possible as a variation of the embodiment shown. Similar to the variation of FIG. 3, the slit sliding bushing 28′ as well is arranged in the mounted condition with axial play between the ring 31′ and the head piece 26 of the pin 22′.

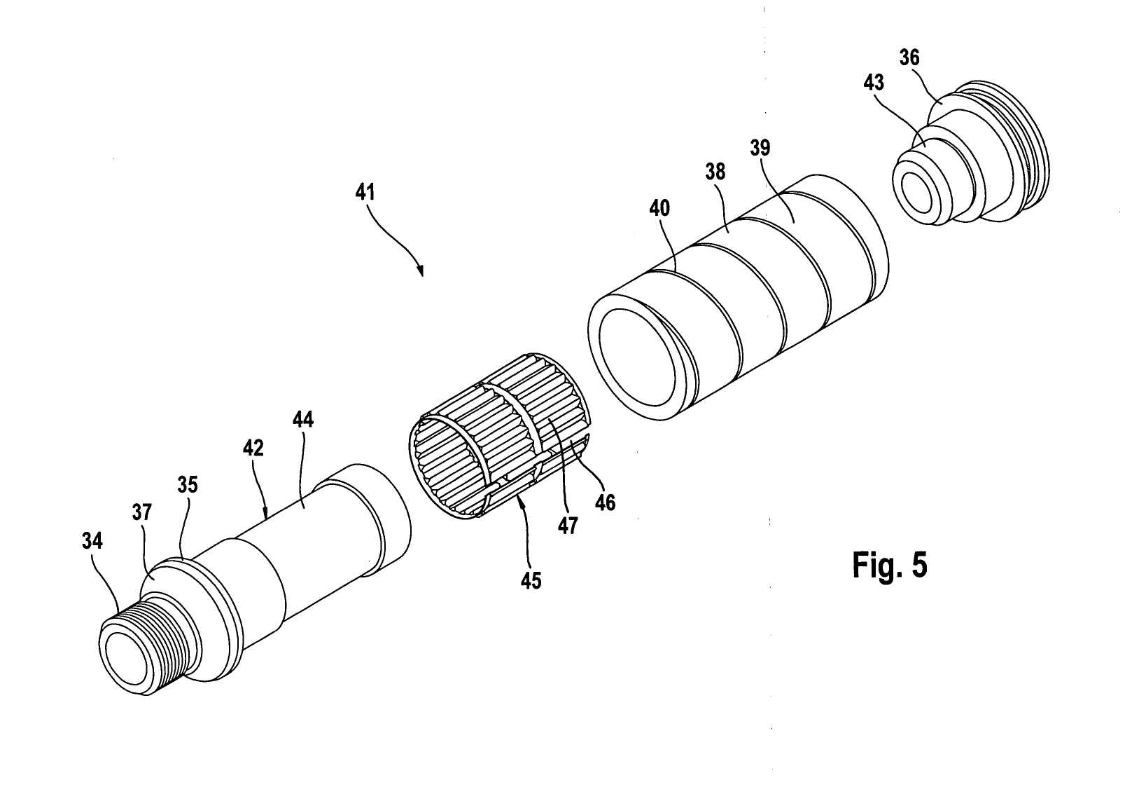

FIGS. 5 to 7 illustrate an alternative embodiment of the multipart guide pin 41. Accordingly, the pin 42 embraces already the ring 35 with the conical surface 37 and the screw coupling 34 for screwing of the entire guide pin 41. However, in contrast to the variations described hereinabove, the head piece 36 at the opposite pin end is not connected integrally with the pin 42. Rather, the head piece 36 is detachably connected to pin 42 using a pivot 43. The pivot 43 may e.g. be fastened at pin 42 by means of a press fit or a threaded connection. It is, however, principally suitable for this arrangement as well, for weight economy reasons, to provide the pin 42 and the head piece 36 preferably with a hollow design. Due to the separate configuration of the head piece 36, the assembly of the respectively employed elastic sleeve 45, 50, 55 and the sliding bushing 38 is generally simplified. To this end, the elastic sleeve 45, 50, 55 and the sliding bushing 38 are slipped onto the pin 42, and the head piece 36 is attached to the pin 42 only subsequently. Compared to the variations that have been explained previously, the sliding bushing 38 additionally includes a spiral-shaped circumferential groove 40 at the guiding portion 39. Favorably, a lubricant can be introduced into this groove 40 in order to constantly safeguard ease of slidability of the guide pin 41 in the associated guide bore. Naturally, it is also possible to arrange for the course of the groove at the guiding portion in a different way.

According to FIGS. 5 to 7, the elastic sleeve 45, 50, 55 is respectively configured as a tolerance sleeve 45, 50, 55, and the radially elastic effect is basically due to the specific sleeve design rather to the sleeve material. The tolerance sleeve 45, 50, 55 in the mounted condition of the guide pin 41 is anchored axially at the pin 42 by way of an offset pin portion 44. In the case at issue, the tolerance sleeve is in each case made of a material having only insignificant elastic properties. With respect to simple processing, metal or sheet metal proves to be a favorable material for the tolerance sleeve 45, 50, 55. In detail, the radially elastic effect of the tolerance sleeve 45, 50, 55 is realized by an appropriate profiling, or by other extensions shaped at the tolerance sleeve 45, 50, 55.

In a first variation according to FIG. 5, the tolerance sleeve 45 is favorably made of a plane metal blank and reshaped cylindrically. Thus, the tolerance sleeve 45 has a slit design, the sleeve ends being separated by a slot 46. At its periphery, the tolerance sleeve 45 has a profiling 47, which is formed of axially parallel extending elevations and indentations. The profiling 47 renders the tolerance sleeve 45 radially elastically resilient at least within limits.

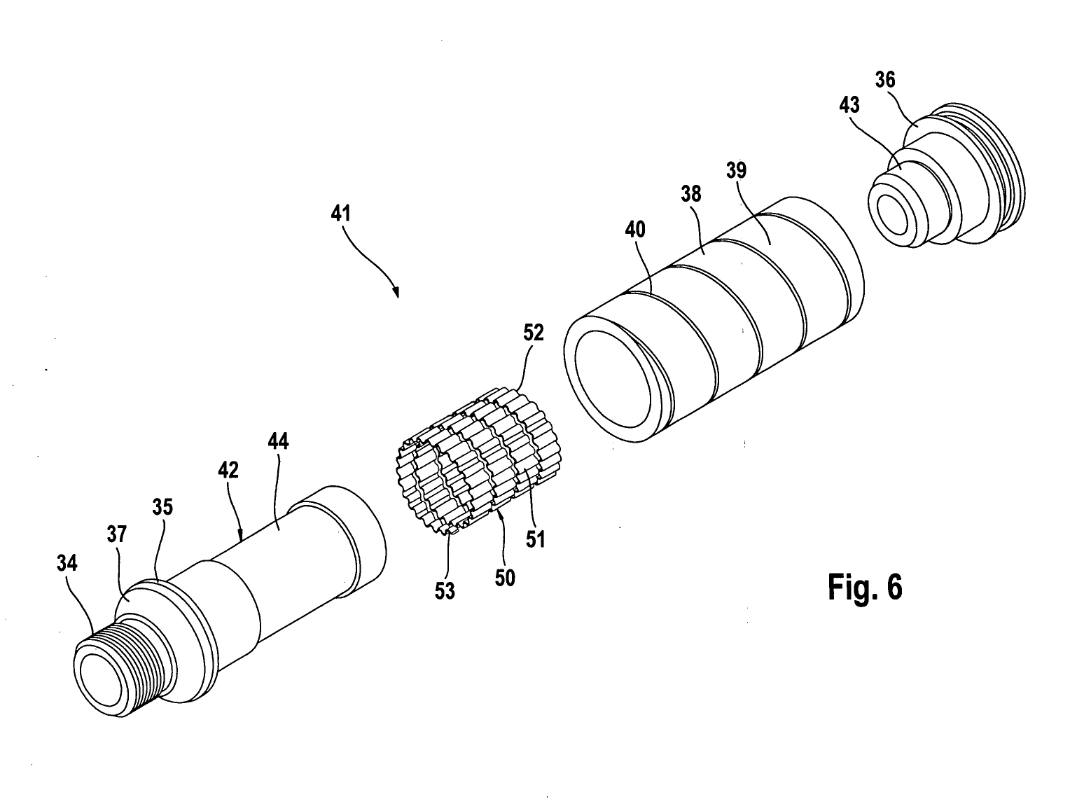

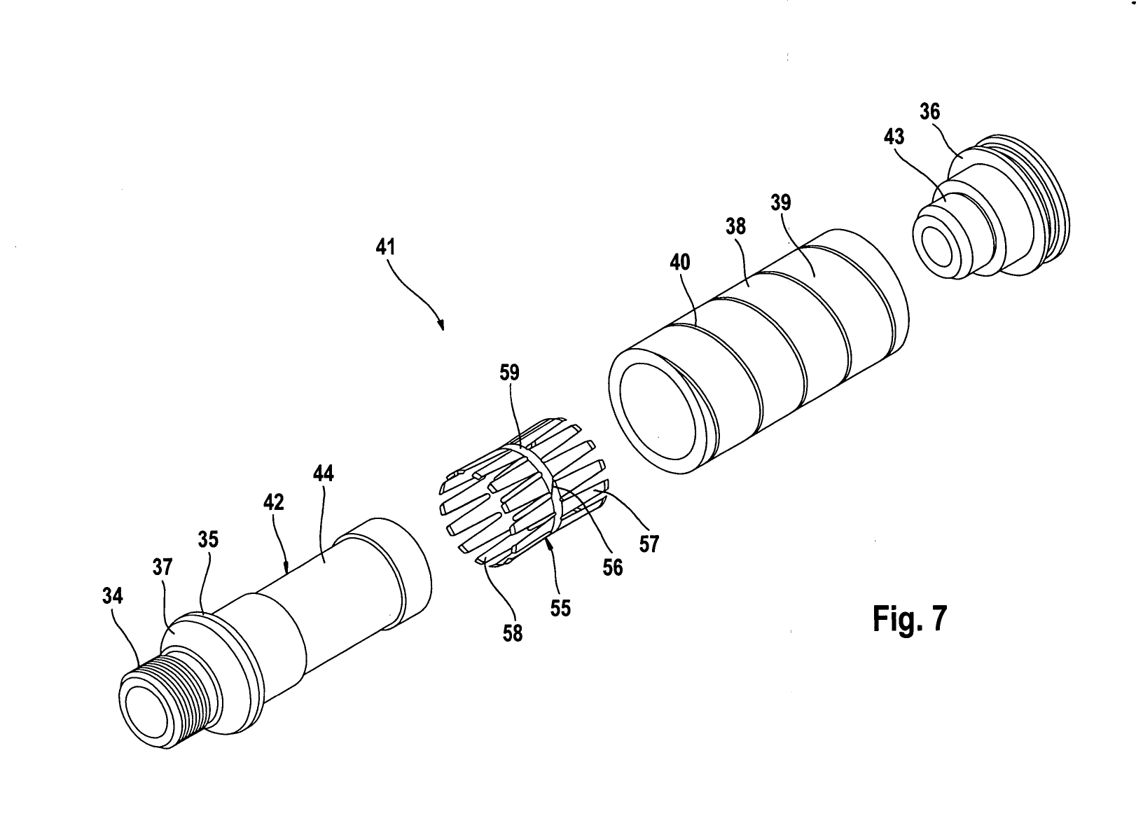

FIG. 6 illustrates an alternative of the tolerance sleeve 50, which is wound up in a spiral manner from a strip-shaped metal blank 52. In the beginning, the metal blank 52 is designed like corrugated sheet, the single corrugations extending transversely in relation to the alignment of the strips. A substantially paraxial course is achieved therefrom for the undulated profiling 51 after the spiral-shaped winding. The strip ends 53 advantageously undergo a mechanical finishing operation, in particular, a grinding operation, in order to reach a configuration as cylindrical as possible for the entire tolerance sleeve.

Another variation of a tolerance sleeve 55 can be taken from FIG. 7, which is likewise designed as a metallic component. In this case, too, it is suitable to make the tolerance sleeve 55 of a plane metal blank, which is subsequently wound up to become a cylindrical sleeve. The slit sleeve is isolated by a slot 56 at its points of impact. A profiling 57, which is formed of several radial extensions 58, achieves the radially elastic effect of the tolerance sleeve 55. The extensions 58 have the shape of resilient tabs that extend axially on both sides like a crown. The resilient tabs are kept together in the middle by a band-like portion 59.

The tolerance sleeves 45, 50, 55 shown are elastically deformable at least to a limited extent due to the respective profiling 47, 51, 57. When this limit of elastic deformation is exceeded, the multipart guide pin 41 is in a position to transmit brake circumferential forces at least to a defined extent. It may be suitable for this purpose to arrange for at least one radial stop (not shown) at the elastic sleeve 23 or the tolerance sleeve 45, 50, 55. This radial stop may e.g. be shaped as a radial elevation at the elastic sleeve 23 or tolerance sleeve 45, 50, 55. Thus, the radial stop allows the targeted transmission of brake circumferential forces through the guide pin 41, above all when a predefined force threshold is exceeded.

In principle, the multipart guide pin 21, 21′, 41 at most accommodates a very small portion of the brake circumferential forces. The transmission of a defined portion through the multipart guide pin 21, 21′, 41 is possible at most at very high total brake circumferential brake forces. The second pin guide 20 with guide pins 21, 21′, 41 mainly serves for positioning the floating caliper 2 perpendicular to the direction of displacement thereof. The multipart design of the guide pin 21, 21′, 41 favorably allows a purposeful and independent design of the individual components.

The two guiding portions 15, 29, 39 of the carrier pin 11 and the guide pin 21, 21′, 41 have identical outside diameters. More particularly, the overall outside dimensions of the carrier pin 11 and the guide pin 21, 21′, 41 are equal. Hence, identical dimensions result also for the corresponding accommodating bores 4 in the floating caliper 2 or the component fixed to the vehicle, respectively. Consequently, floating-caliper disc brakes of this type with pin guides 10, 20 can be installed flexibly on both vehicle sides without structural modifications. In addition, it is possible to determine the respective position (on the entry side/exit side) of the carrier pin 11 individually. This allows the construction scope when the floating-caliper disc brake is designed. It can be suitable to provide the guiding portions 15, 29, 39 with an appropriate sliding layer in order to additionally improve ease of motion of the pin guides 10, 20.

1.-9. (canceled)

10. A floating-caliper disc brake of a motor vehicle
with a component fixed to the vehicle,
with a floating caliper (2) and
with at least two pin guides (10, 20) for the displaceable arrangement of the floating caliper (2) at the component fixed to the vehicle, each of the pin guides having a guiding portion and a pin and being attached with a first end (12) by means of the pin (11, 21, 21′, 41) to the component fixed to the vehicle or at the floating caliper (2), respectively, while being arranged with a second end (13) provided by the guiding portion (15, 29, 39), in a displaceable manner, in a bore (4) of the floating caliper (2) or of the component fixed to the vehicle,
with a first pin guide (10) for the transmission of brake circumferential forces and a second pin guide (20) for positioning the floating caliper (2) perpendicular to its direction of displacement,
wherein the second pin guide (20) includes a multipart guide pin (21, 21′, 41), with a pin (22, 22′, 42), an elastic sleeve (23, 45, 50, 55) encompassing the pin (22, 22′, 42), and with a sliding bushing (28, 28′, 38) encompassing the elastic sleeve (23, 45, 50, 55).

11. The floating-caliper disc brake as claimed in claim 10,
wherein the first pin guide (10) includes a one-piece carrier pin (11).

12. The floating-caliper disc brake as claimed in claim 11,
wherein the carrier pin (11) at its first end (12) is defined by way of a conical surface (17) at the component fixed to the vehicle or at the floating caliper (2), respectively.

13. The floating-caliper disc brake as claimed in claim 10,
wherein the guiding portion (15) of the first pin guide (10) and the guiding portion (29, 39) of the second pin guide (20) have the same outside diameter.

14. The floating-caliper disc brake as claimed in claim 10,
wherein the multipart guide pin (21, 21′, 41) has a conical surface (27, 27′, 37) at the first end.

15. The floating-caliper disc brake as claimed in claim 10,
wherein the elastic sleeve (23, 45, 50, 55) is provided on at least an inside or an outside surface with an appropriate profiling (25, 47, 51, 57) for an adjustment of an elastic effect perpendicular to the direction of displacement.

16. The floating-caliper disc brake as claimed in claim 10,
wherein the elastic sleeve (23), at least in sections, is composed of an elastic material, in particular rubber material.

17. The floating-caliper disc brake as claimed in claim 10,
wherein the elastic sleeve is designed as a tolerance sleeve (45, 50, 55), which is made of a material of low elastic properties at least in sections, and permits a limited elastic deformation in a radial direction due to its appropriate configuration.

18. The floating-caliper disc brake as claimed in claim 10,
wherein the elastic sleeve (23, 45, 50, 55) permits a limited elastic deformation in a radial direction with respect to the pin axis, and includes a radial stop.
